(19) United States
(12) Patent Application Publication
(10) Pub. No.: US 2018/0113815 A1
(43) Pub. Date: Apr. 26, 2018

(54) CACHE ENTRY REPLACEMENT BASED ON PENALTY OF MEMORY ACCESS

(71) Applicant: Advanced Micro Devices, Inc., Sunnyvale, CA (US)

(72) Inventors: Yasuko Eckert, Bellevue, WA (US); Bo Wu, Arvada, CO (US); Nuwan Jayasena, Sunnyvale, CA (US); Dong Ping Zhang, Sunnyvale, CA (US)

(21) Appl. No.: 15/331,099

(22) Filed: Oct. 21, 2016

(51) Int. Cl. G06F 12/126; G06F 12/0808; G06F 12/0891

(52) U.S. Cl. CPC G06F 12/126; G06F 12/0808; G06F 12/0891; G06F 2212/69; G06F 2212/1028; G06F 2212/154; G06F 2212/1016

(57) ABSTRACT

A processing system selects data for eviction at a cache based at least in part on a penalty associated with accessing the data at the memory location from which the data was transferred to the cache. The penalty reflects the amount of time and resources expended in copying the data from memory to the cache. By assigning priorities to the data stored at a cache based on the penalty incurred in accessing the data at the memory location from which it was transferred to the cache and selecting data for eviction from the cache based in part on the assigned priority, the processing system can preferentially select for eviction from the cache data that was transferred from a local memory to the cache rather than data that was transferred from a remote memory to the cache.

### GOVERNMENT LICENSE RIGHTS

This invention was made with Government support under Prime Contract Number DE-AC52-07NA27344, Subcontract Number B609201 awarded by Department of Energy (DOE). The Government has certain rights in this invention.

### BACKGROUND

### Description of the Related Art

To support execution of instructions, processing systems typically implement one or more compute complexes, each compute complex having one or more processor cores and a memory hierarchy having memory modules to store data to be accessed by the executing instructions. Each processor core is associated with one or more levels of caches that are local to the corresponding processor core (hereinafter, the “local caches”) and a main memory that stores a larger quantity of data that can be accessed by the executing instructions at the corresponding processor core. In the course of executing instructions, a processor core may access data that is stored at a local cache, at a main memory from which accesses initiated by the processor core may be performed relatively quickly and with a relatively low expenditure of energy (hereinafter, the “local main memory”), or at a main memory from which accesses initiated by the processor core may be performed relatively slowly and with a relatively high expenditure of energy (hereinafter, “remote memory”).

Typically, the more proximate to a processor that data is stored in the memory hierarchy, the more quickly and energy-efficiently it can be accessed by the processor. For example, accesses of data stored at a local cache corresponding to a given processor core may be performed faster and consume less energy than access of data stored at a local main memory, and accesses of data stored at a local main memory may be performed faster and consume less energy than accesses of data stored at a remote memory. To further enhance processing efficiency, the processing system can implement a memory management protocol that governs the particular set of data stored at each level of the memory hierarchy. For example, the processing system can implement a memory management protocol that moves data that has recently been requested for access to levels of the memory hierarchy closer to the processor core, with the expectation that the data will be accessed again by the processor core in the near future, and moves data that has not been accessed recently to more remote levels of the memory hierarchy. However, this general memory management protocol can result in frequent movement of data between levels of the memory hierarchy, impacting both processing efficiency and power consumption of the processing system.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system employing a memory hierarchy wherein one cache selects data for replacement based on a penalty associated with retrieving the data from main memory to the cache in accordance with some embodiments.

FIG. 2 is a block diagram of an example of the processing system of FIG. 1 assigning priorities to data stored at a cache based on the local and remote memory locations from which the data was transferred to the cache in accordance with some embodiments.

FIG. 3 is a block diagram of an example of the processing system of FIG. 1 selecting data for eviction from a cache based in part on the assigned priority of the data in accordance with some embodiments.

FIG. 4 is a flow chart of a method of selecting data for eviction from cache based in part on a penalty associated with accessing the data at the location in memory from which it was transferred to the cache in accordance with some embodiments.

### DETAILED DESCRIPTION

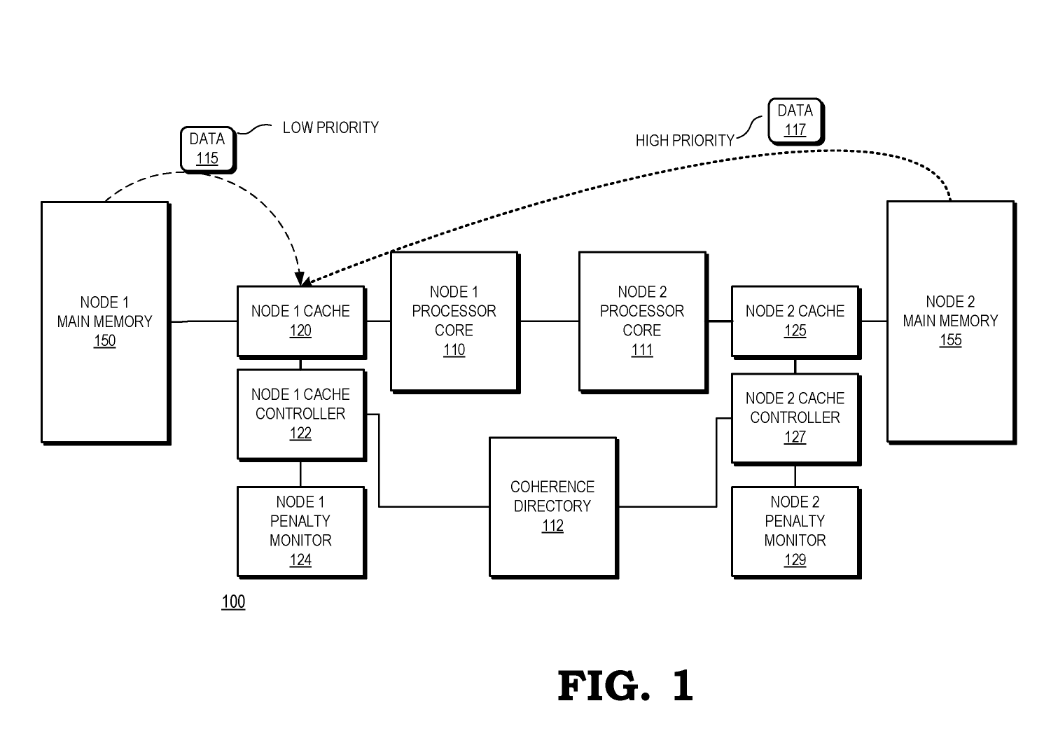

FIGS. 1-4 illustrate techniques for improving memory management efficiency at a processing system by selecting data for eviction at a cache based at least in part on a penalty associated with accessing the data at the memory location from which the data was transferred to the cache. In some embodiments, the penalty is the amount of time and resources expended in copying the data from memory to the cache. To illustrate, in a multicore processing system in which each core is associated with a memory hierarchy having one or more levels of caches and a main memory (each core and its associated memory hierarchy is referred to herein as a “node”), and in which memory accesses may traverse one or more nodes, each memory access may incur a different penalty. For example, accessing data stored at a local main memory incurs a lower penalty than accessing data stored at a remote memory, because the data can be accessed at the local memory with lower latency and using less energy. Further, in heterogeneous memory architectures, accesses at different locations within a given memory module may incur different penalties. Because accessing data at various memory locations incurs varying penalties, filling a cache miss for data incurs a penalty that is dependent on the memory location from which the data was transferred to the cache.

Typically, data may be selected for replacement or eviction from a cache based on how recently the data was used by the associated processor core, e.g., by implementing a least-recently-used (LRU) replacement policy. However, an LRU replacement policy does not differentiate between data from local and remote memories, and therefore may result in the selection of remote data for eviction from the cache while leaving local data resident in the cache. When the eviction of the data results in a subsequent cache miss for the evicted data, the data must be re-accessed by the processing system at the remote memory location from which it was previously copied to the cache, resulting in longer latency and expenditure of resources (such as energy) than would result from a cache miss for data stored at a local memory location. By assigning priorities to the data stored at a cache based on the penalty incurred in accessing the data at the memory location from which it was transferred to the cache and selecting data for eviction from the cache based in part on the assigned priority, the processing system can preferentially select for eviction from the cache data that was transferred from a local memory to the cache rather than data that was transferred from a remote memory to the cache. The processing system thereby reduces the number of evictions of data originating from remote memory locations, which results in reduced power consumption and improved memory efficiency.

FIG. 1 illustrates an example of a processing system 100 configured to assign a priority, at a given cache level, to data transferred to the cache based on the penalty incurred in accessing the data at the memory location from which the data was transferred, and to select data for eviction from the cache based in part on the assigned priority in accordance with some embodiments. The processing system 100 can be employed in any of a number of devices, such as a personal computer, workstation, mobile device such as a smartphone, a video game console, smart TV, and the like. The processing system 100 includes one or more processor cores 110, 111, one or more levels of cache (e.g., node 1 cache 120, node 2 cache 125) associated with each processor core, respectively, and one or more main memories (e.g., main memories 150, 155) associated with each processor core, respectively. Although FIG. 1 illustrates a single main memory associated with each processor core, in some embodiments each processor core is associated with more than one main memory device. Each processor core and its associated levels of cache and main memory are referred to as a “node.” Although the processing system 100 is depicted in FIG. 1 as containing two nodes, the processing system 100 may contain a single node or more than two nodes. The processing system 100 further includes a coherence directory 112 to maintain memory coherence among the nodes. In some embodiments, each processor core 110, 111 and its associated one or more levels of cache 120, 125, including associated cache controllers 122, 127 and penalty monitors 124, 129 for each cache, form a processor incorporated on a single semiconductor die, with each of the main memories 150, 155 incorporated on one or more separate semiconductor dies.

The node 1 and node 2 processor cores 110, 111 include one or more instruction pipelines to execute instructions, thereby carrying out tasks on behalf of an electronic device. While each of the node 1 and node 2 processor cores 110, 111 may have some amount of integral memory, for example, in the form of a register file, such memory is typically limited in storage capacity. Accordingly, in order to execute instructions, the node 1 and node 2 processor cores 110, 111 store and retrieve data from the memory hierarchies of the processing system 100, including the node 1 cache 120, node 2 cache 125, and main memories 150, 155. In particular, in the course of executing instructions, the processor cores 110, 111 generate operations, referred to as memory access requests, to store data at (a store operation) or load data from (a read operation) the memory hierarchies. The node 1 cache 120, node 2 cache 125, and main memories 150, 155 work together to satisfy the memory access requests, as described further herein.

The node 1 cache 120 and node 2 cache 125 are memory modules that store data for access by the node 1 and node 2 processor cores 110 and 111, respectively. In at least one embodiment, the node 1 cache 120 and node 2 cache 125 are each composed of a set of entries, each of which can store an associated unit of data referred to as a cache line. The node 1 cache controller 122 is a module configured to receive memory access requests for data from the processor core 110 and search the node 1 cache 120 to determine if one of the cache entries stores a cache line associated with the memory address targeted by the memory access request. If the requested cache line is found in the node 1 cache 120, a cache hit has occurred. In the event of a cache hit, the node 1 cache controller 122 satisfies the memory access request by, in the case of a read operation, providing the requested cache line from the node 1 cache 120 to the processor core 110 or, in the case of a write operation, storing the write data to the cache entry.

Similar to the node 1 cache controller 122, the node 2 cache controller 127 is a module configured to receive memory access requests for data from the processor core 111 and search the node 2 cache 125 to determine if one of the cache entries stores a cache line associated with the memory address targeted by the memory access request. If the requested cache line is found in the node 2 cache 125, a cache hit has occurred. In the event of a cache hit, the node 2 cache controller 127 satisfies the memory access request by, in the case of a read operation, providing the requested cache line or a portion thereof from the node 2 cache 125 to the processor core 111 or, in the case of a write operation, storing the write data to the cache entry.

The processing system 100 further includes a coherence directory 112 to store address and coherency state information for cachelines of the node 1 and node 2 memory hierarchies. To this end, the coherency directory 112 is implemented as a cache, array, table, latches, flops, or other storage configuration so as to include entries hierarchically arranged as a plurality of “banks”, a plurality of indices, and a plurality of ways. That is, each entry in the coherence directory 112 corresponds to a particular bank, index and way combination. Each entry in the coherence directory 112 tracks information for a corresponding cacheline present in one of the node 1 or node 2 caches 120, 125. The information stored at an entry in the coherence directory 112 for the corresponding cacheline includes, for example, the physical address (or portion thereof) of the cacheline as well as state of the cacheline at the node 1 or node 2 cache 120, 125. Each bank contains a plurality of indices and ways and represents the entries used to track the cachelines present in one of the node 1 or node 2 caches 120, 125. Thus, for the example of FIG. 1, the coherence directory 112 includes two “banks,” one for each of the two node 1 and node 2 caches 120, 125.

The coherence directory 112 is generally employed by the node 1 and node 2 cache controllers 122, 127 to respond to cache probes generated by caches of the node 1 and node 2 cache hierarchies. In particular, the node 1 and node 2 caches 120, 125, implement a memory coherency protocol (referred to herein as a “coherency protocol”). Each cacheline is associated with corresponding coherency information, as governed by the coherency protocol, to indicate the coherency state of the cacheline, as well as how the cacheline may be handled under the rules of the coherency protocol. For example, the coherency protocol may establish coherency states such as “modified” indicating that the cacheline can be modified at the corresponding cache, “exclusive” indicating that the corresponding cacheline cannot be modified at caches associated with other processor cores, and “shared” indicating that the cacheline is shared by multiple caches of the cache hierarchy and therefore should not be modified. For specified events, as defined by the particular coherency protocol implemented by the processing system, a cache of the processing system 100 issues a cache probe to identify the coherency status of a given cacheline at other caches. For example, prior to changing the coherency status of a cacheline from shared to exclusive, a cache issues a cache probe to identify whether the cacheline is stored at any other cache and, if so, the coherency status of the cacheline at the caches that store the cacheline. Based on responses to the probe, the cache that issued the probe takes appropriate action, as required under the rules of the coherency protocol. For example, if no other caches store the cacheline, the cache changes the state of the cacheline from “shared” to “exclusive.”

As indicated above, the coherence directory 112 stores entries indicating the cachelines stored at each of the cache and memory modules of the processing system 100. In response to a cache probe, the node 1 or node 2 cache controller 122, 127 accesses the coherence directory 112 to determine whether any of the caches or memory modules of the processing system 100 stores the cache line and, if so, the corresponding coherency information. Based on the information stored at the coherence directory, the node 1 or node 2 cache controller 122, 127 provides a response to the cache probe.

If the requested cache line is not found in the node 1 or node 2 cache 120, 125, a cache miss has occurred. In the event of a cache miss, the node 1 or node 2 cache at which the cache miss occurred issues a coherency probe to the associated node 1 or node 2 cache controller 122, 127, which in turn accesses the coherence directory 112 to determine whether any of the other caches or memory modules of the processing system 100 store the cache line and, if so, the corresponding coherence information. The coherence directory 112 generates a response to the cache probe indicating the memory module (cache or main memory) that stores the most up-to-date copy of the data targeted by the memory access request. Responsive to the cache probe response, the node 1 or node 2 cache controller 122, 127 provides a memory access request to the cache or main memory identified by the response to the cache probe. Thus, as described above, the memory access request traverses the memory hierarchy until the requested data is found. The requested data is then transferred to the cache corresponding to the processor core from which the memory access request originated, and the memory access request is satisfied at the cache. This transfer of data to the cache is referred to herein as “filling” a cache miss.

The node 1 penalty monitor 124 and the node 2 penalty monitor 129 assess the penalty incurred in filling cache misses at the node 1 cache 120 and node 2 cache 125, respectively. In some embodiments, the penalty monitors 124, 129 determine whether a cache miss is filled from a local memory or a remote memory. In some embodiments, the penalty monitors 124, 129 determine an expected cost of filling a cache miss for data transferred to the respective caches 120, 125 (“the destination cache”) based on design parameters such as statistical latency, bandwidth, and energy per cache line load for accesses at the memory location from which the data was transferred. In some embodiments, the penalty monitors 124, 129 determine an expected cost of filling a cache miss for data transferred to the respective caches 120, 125 dynamically, using run-time information such as current latency, bandwidth, and energy per cache line load for accesses at the memory location from which the data was transferred to the destination cache.

For example, if data 115 is transferred from the node 1 main memory 150 to the node 1 cache 120, the node 1 penalty monitor 124 assesses a low penalty for a future cache miss at the node 1 cache 120 for data 115, because the node 1 main memory 150 is local to the node 1 cache 120, and the data 115 traverses a relatively short signal path from the node 1 main memory 150 to the node 1 cache 120, thereby resulting in lower latency and energy use than would a cache miss from a remote memory. Conversely, if data 117 is transferred from the node 2 main memory 155 to the node 1 cache 120, the node 1 penalty monitor 124 assesses a high penalty for a future cache miss at the node 1 cache 120 for data 117, because the node 2 main memory 155 is remote from the node 1 cache 120, and the data 117 traverses a relatively long signal path from the node 2 main memory 155 to the node 1 cache 120, thereby resulting in higher latency and energy use than would a cache miss from a local memory.

The node 1 and node 2 penalty monitors 124, 129 provide a penalty assessment to the respective associated cache controllers 122, 127 for each cache line transferred to the respective associated caches 120, 125. The cache controllers 122, 127, in turn, assign a priority to each cache line transferred to the respective caches 120, 125 corresponding to the penalty assessment provided by the penalty monitors 124, 129. For example, if the penalty assessment for a cache line is high, such as with data 117, because the penalty associated with accessing the cache line at the memory location from which it was transferred to the destination cache is high, the cache controller 122 or 127 assigns a high priority to the cache line. Conversely, if the penalty assessment for a cache line is low, such as with data 115, because the penalty associated with accessing the cache line at the memory location from which it was transferred to the destination cache is low, the cache controller 122 or 127 assigns a low priority to the cache line. As described further herein, the lower priority cache lines are more likely to be replaced from the caches 120, 125. Accordingly, over time, the caches 120, 125 are more likely to retrieve cache lines having lower penalties, thereby conserving processor resources and improving memory access efficiency.

In some embodiments, the cache controllers 122, 127 assign a priority to each cache line based in part on a value or values provided by a programmer, a compiler, a profiler or an operating system (OS). For example, the OS, dynamic compilers, or profilers can monitor the access patterns, and dynamically assign or change a priority value associated with a cache line based on the cost of remote-memory accesses or the anticipated reuse of data accessed from remote memory. In some embodiments, software data layout management is aware of remote data with temporal locality and is able to assign higher priority to such data. Software may communicate these priority values (and their changes) to the cache management hardware via modifying priority fields associated with OS page table entries or by programming special-purpose registers indicating priorities for memory address ranges. Alternatively, different load and store instructions may be used to convey priority levels associated with the cache lines accessed by them.

In some embodiments, each of the node 1 cache 120 and node 2 cache 125 is a set associative cache, wherein each cache is divided into a number of sets. Each set includes a number of ways, with each way corresponding to a cache entry that can store a cache line. Each set only stores a cache line associated with subset of memory addresses, wherein the subset associated with a set is identified by the corresponding cache controller based on a portion of the memory address referred to as the index. By employing set associativity, the caches 120 and 125 facilitate relatively quick identification of cache misses and cache hits.

In some embodiments, the caches 120 and 125 are sized such that they typically are unable to store, at a given point in time, all the data that is requested, or may be requested, by the processor cores 110, 111, thereby requiring data to be transferred through the memory hierarchy as described above. To manage the finite cache space, each of the cache controllers 122 and 127 implements a replacement policy to identify if there is an entry in a set available to store a received cache line and, if not, to select one of the entries in the set for replacement. The availability of a cache entry is indicated by status information associated with the entry, referred to as the valid status of the entry. In particular, a cache line having an invalid validity status (referred to herein as an invalid cache line) is one that is available to store the received data and a cache line having a valid validity status (referred to herein as a valid cache line) is one that is already occupied by other data and therefore is not available to store data unless the cache line's address matches the address of the received data or the currently stored data is replaced. To replace a valid cache line with an incoming cache line, the cache controller for the cache first evicts the valid cache line by transferring it to one or more other levels of the memory hierarchy if the data has been modified at the cache, informing the coherency directory 112 of the eviction, and storing the incoming cache line at the entry.

To illustrate, in response to a reset of the processing system 100, all cache lines in each of node 1 cache 120 and node 2 cache 125 are set by their respective cache controller to an invalid state. As a cache entry is populated with a cache line retrieved from main memory 150 or 155, the corresponding cache controller sets the cache entry to a valid state. A cache way containing a cache line that has been set to an invalid state may receive an incoming cache line, which will displace or overwrite the invalid cache line. When a cache receives a cache line to be stored, the set where the cache line is to be stored is determined by the cache line's address. Within the set, the cache selects a cache way where the cache line is to be stored. If the cache set associated with the incoming cache line has room available (i.e., has one or more cache ways indicated as containing invalid cache lines), the incoming cache line will be stored at one of the invalid ways. However, if all cache ways in the set associated with the incoming cache line are indicated as valid, the cache controller selects a cache line of the set associated with the new cache line to be evicted to make room for the incoming cache line.

The particular criteria employed by a cache controller to select the cache line for replacement is referred to as a replacement policy. For example, the cache controllers 122, 127 may implement a replacement policy at the caches 120, 125 wherein they select for eviction the least recently used cache line (that is, the cache line that was least recently the target of a memory access operation) in the cache set associated with the incoming cache line.

To facilitate processing efficiency, the node 1 and node 2 cache controllers 122, 127 implement a replacement policy based on the penalty associated with filling a cache miss at the associated cache 120, 125 from the location in memory from which the data was transferred to the cache 120, 125. For example, the penalty associated with filling a cache miss at the node 1 cache 120 is lower for data that was previously transferred to the node 1 cache 120 from node 1 main memory 150 than for data that was previously transferred to the node 1 cache 120 from node 2 main memory 155. Thus, the node 1 cache controller 122 can select for eviction from the node 1 cache 120 a cache line that was previously transferred to the node 1 cache 120 from the node 1 main memory 150 to make room for an incoming cache line. The node 1 cache controller 122 therefore may not have to evict a cache line that was previously transferred to the node 1 cache 120 from the node 2 main memory 155 in order to make room for the incoming cache line unless the corresponding set has no cache lines from the main memory 150. By selecting a cache line for eviction based at least in part on the penalty incurred in filling a subsequent cache miss for the cache line being evicted, the processing system 100 can reduce the number of subsequent cache misses for cache lines stored at remote memory locations, conserving energy and improving memory efficiency.

To illustrate, in operation, node 1 processor core 110 executes a memory access operation. The node 1 processor core 110 requests the data (a cache line) from node 1 cache controller 122, which searches the node 1 cache 120 for the requested cache line. If the requested cache line is found in the node 1 cache 120, the requested cache line is provided to the node 1 processor core 110. If the requested cache line is not found in the node 1 cache 120, the node 1 cache controller 122 determines where the cache line can be found in main memory. If the requested cache line is found in the node 1 main memory 150, the node 1 cache controller 122 copies the requested cache line to the node 1 cache 120. The node 1 penalty monitor 124 assesses a penalty associated with copying the requested cache line from the node 1 main memory 150 to the node 1 cache 120, and provides the penalty assessment to the node 1 cache controller 122, which assigns a priority to the cache line corresponding to the assessed penalty. The node 1 cache controller 122 then reads the requested cache line from the node 1 cache 120 to the node 1 processor core 110.

If the address of the requested cache line maps to the node 2 main memory 155, the node 1 cache controller 122 requests the cache line from the node 2 main memory 155. In response, the node 2 main memory 155 provides the requested data to the node 1 cache controller 122 for storage at the node 1 cache 120. The node 1 penalty monitor 124 assesses a penalty associated with copying the requested cache line from the node 2 main memory 155 to the node 1 cache 120, and provides the penalty assessment to the node 1 cache controller 122, which assigns a priority to the cache line corresponding to the assessed penalty. In this example, the penalty associated with copying the requested cache line from the node 2 main memory 155 to the node 1 cache 120 is higher than the penalty associated with copying a cache line from the node 1 main memory 150 to the node 1 cache 120, due to the remoteness of the node 2 main memory 155 from the node 1 cache 120. Thus, the priority assigned to the cache line that was copied from the node 2 main memory 155 to the node 1 cache 120 will be higher than the priority assigned to a cache line that was copied from the node 1 main memory 150 to the node 1 cache 120. The node 1 cache controller 122 then reads the requested cache line from the node 1 cache 120 to the node 1 processor core 110.

If no cache sets in the node 1 cache 120 are available to store the requested cache line, the node 1 cache controller 122 selects a cache line from a cache set for eviction and replacement. In making its selection, the node 1 cache controller 122 compares the priorities of the cache lines residing in the cache set with which the incoming cache line is associated to determine which cache line has the lowest priority. The lowest priority cache line is preferred for eviction from the node 1 cache 120, because a subsequent cache miss for that cache line will result in a memory access having a relatively low penalty. Such a preference may be considered by the node 1 cache controller 122 among other factors, such as the least recently used cache line residing in the node 1 cache 120 set with which the incoming cache line is associated. For example, the node 1 cache controller 122 can assign to each cache line an age value, and adjust the age value based on a number of criteria, including the last time the cache line was the target of a memory access operation from node 1 processor core 110, whether the cache line is likely to be written by other processor cores, and the like. The age value for a given cache line thus reflects, for that cache line, the combination of different replacement policy criteria. When selecting a cache line of a set for eviction, the node 1 cache controller 122 can select the cache line based on a comparison of the age values for the cache lines in the set as well as the priority values for the cache lines in the set. In some embodiments, the age values and priority values are combined using a weighted average of the corresponding values, with the weights adjusted during configuration of the processing system 102 to achieve desired performance criteria.

Once a cache line has been evicted from the node 1 cache 120, the node 1 cache controller 122 copies the incoming requested cache line to the node 1 cache 120. The node 1 cache controller 122 then provides the requested cache line to the node 1 processor core 110.

It will be appreciated that different cache controllers of the processing system 100 may implement different replacement schemes at their respective caches. For example, the node 1 cache controller 122 can select entries for replacement at the node 1 cache 120 based at least in part on the penalty incurred in filling a subsequent cache miss for the data at the memory location from which the data was transferred to the node 1 cache 120 as described above. In contrast, the node 2 cache controller 127 can select entries for replacement at the node 2 cache 125 without regard to the penalty incurred in filling a subsequent cache miss for the data at the memory location from which the data was transferred to the node 2 cache 125. Implementing such different replacement schemes at the different cache controllers can improve overall memory access efficiency at the processing system 100.

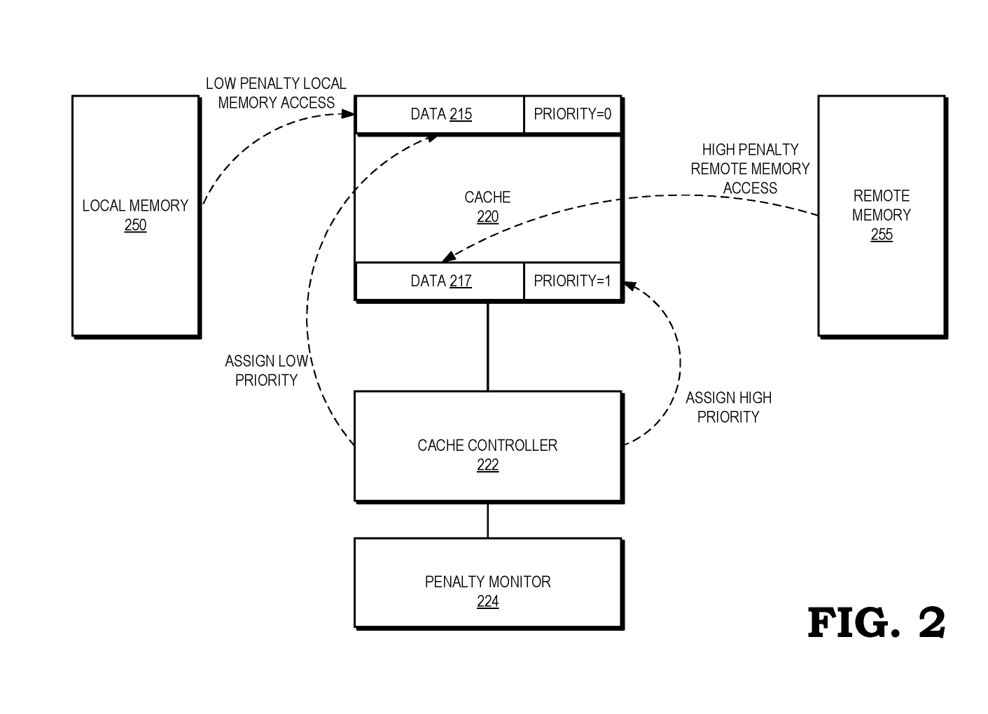

FIG. 2 illustrates an example of the processing system of FIG. 1 assigning replacement priorities to data stored at a cache based on the local and remote memory locations from which the data was transferred to the cache in accordance with some embodiments. In the example of FIG. 2, data 215 is transferred to cache 220 from local memory 250. Penalty monitor 224 assesses a penalty associated with transferring data 215 from the local memory 250 to the cache 220 and provides the penalty assessment to cache controller 222. As described above with respect to FIG. 1, in some embodiments the penalty monitor 224 assesses a given penalty for accesses at the local memory 250 to the cache 220. In such embodiments, all accesses to the local memory 250 are assessed a given penalty, and all accesses to a remote memory 255 are assessed a different penalty. In some embodiments, the penalty monitor 224 assesses the penalty based on design parameters such as statistical latency, bandwidth, and energy per cache line load for accesses to the local memory 250 or the remote memory 255 from the cache 220. In some embodiments, the penalty monitor 224 determines an expected cost of filling a cache miss for data 215 transferred to the cache 220 dynamically, using run-time information such as current latency, bandwidth, and energy per cache line load for accesses to the local memory 250 from which the data was transferred to the cache 220. The penalty monitor 224 provides the penalty assessment to the cache controller 222.

The cache controller 222 assigns a priority to data 215 corresponding to the penalty assessment provided by the penalty monitor 224. For example, if the penalty assessment is relatively low, the cache controller 222 assigns a relatively low priority, such as a value of 0. Conversely, if the penalty assessment is relatively high, the cache controller assigns a relatively high priority, such as a value of 5. In some embodiments, only two levels of priority are assigned by the cache controller 222, for example, a low priority of 0 for data accessed at local memory and a high priority of 1 for data accessed at remote memory. In some embodiments, several levels of priority are assigned by the cache controller 222, for example, a low priority of 0 for data accessed at local memory and a variety of higher priorities for data accessed at different remote memories based on the expected cost of accessing a cache line from the corresponding memory, wherein the cost reflects one or more of static or dynamic access latency, bandwidth, and access energy. In addition, in some embodiments, the cache controller 222 assigns a priority to each cache line based in part on a value or values provided by a programmer, a compiler, a profiler or an OS. In the example of FIG. 2, cache controller 222 assigns a priority of 0 to the data 215.

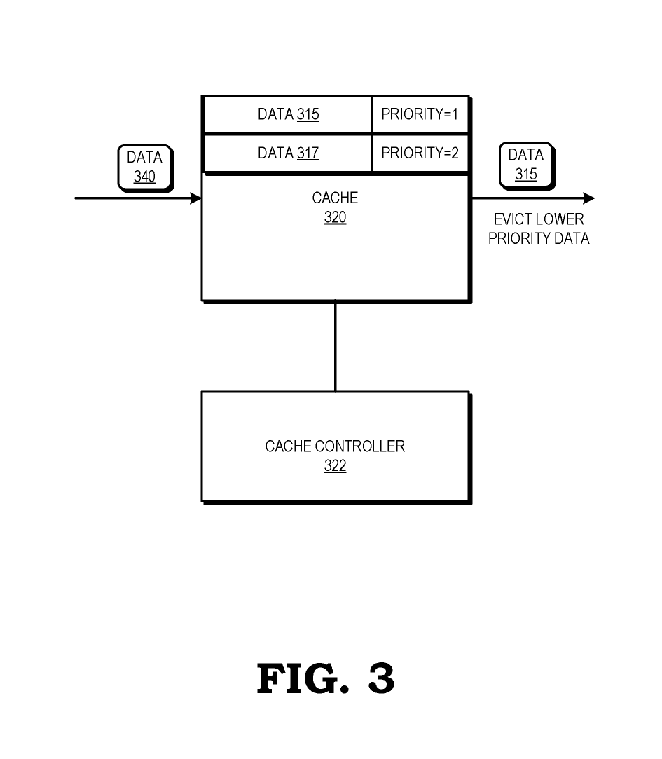

As further illustrated in FIG. 2, data 217 is transferred to cache 220 from remote memory 255. Penalty monitor 224 assesses a penalty associated with transferring data 217 from remote memory 255 to the cache 220 and provides the penalty assessment to the cache controller 222. The cache controller 222 assigns a priority to data 217 corresponding to the penalty assessment provided by the penalty monitor 224. In the example of FIG. 2, the cache controller 222 assigns a priority of 1 to the data 217. The assigned priorities are employed as part of a cache replacement policy that governs which cache lines are evicted in response to new incoming cache lines. This can be better understood with reference to FIG. 3.

FIG. 3 illustrates an example of the processing system of FIG. 1 selecting data for eviction from a cache based in part on the assigned priority of the data in accordance with some embodiments. In the example of FIG. 3, as incoming data 340 is copied to cache 320, cache controller 322 selects a cache line for eviction from the cache 320 to make room for data 340. Data 315 and data 317 are candidates for eviction from the cache 320, as they are stored in a cache set corresponding to the memory address of the incoming data 340. Data 315 has been assigned a priority of 1, and data 317 has been assigned a priority of 2. The cache controller 322 selects data 315 for eviction from the cache 320, based at least in part on data 315 having a lower priority than data 317. In some embodiments, the cache controller 322 selects data for eviction from the cache 320 based on priority, the frequency with which different cache lines are accessed, the last time each cache line was accessed by the processor, and the like.

In some embodiments, if two or more cache lines in the cache 320 have the same lowest assigned priority, the cache controller 322 selects the least recently used cache line having the lowest assigned priority for eviction from the cache. In some embodiments, after evicting the cache line having the lowest priority from the cache 320, the cache controller 322 reduces the priorities of the remaining cache lines in the set that stored the evicted cache line by 1. In some other embodiments, the priorities of the remaining cache lines in the set are reduced by a different value, such as by 2, or by shifting the priority values to divide the values by approximately 2. In still other embodiments, the priority values for each cache line are periodically reduced by a specified value. In addition, in some embodiments the priority value for a cache line is never reduced below a minimum priority value. By reducing the priorities of the remaining cache lines in the set, the cache controller 322 reduces the likelihood that the cache 320 will become filled with high priority but infrequently used data.

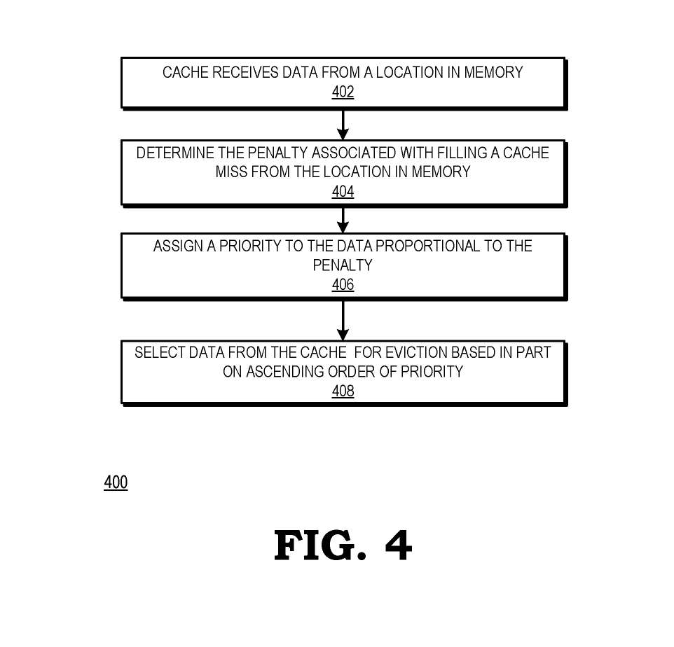

FIG. 4 illustrates a method 400 of selecting data for eviction from a cache based in part on a penalty associated with accessing the data at the location in memory from which it was transferred to the cache in accordance with some embodiments. At block 402, the node 1 cache 120 of FIG. 1 receives data 115 from node 1 main memory 150. At block 404, the node 1 penalty monitor 124 determines the penalty associated with filling a cache miss from the node 1 main memory 150 to the node 1 cache 120 and provides the assessed penalty to the node 1 cache controller 122. At block 406, the node 1 cache controller 122 assigns a priority to the data 115 corresponding to the penalty provided by the node 1 penalty monitor 124. At block 408, the node 1 cache controller 122 selects data for eviction from the node 1 cache 120 based in part on the priority of the data stored at the node 1 cache 120, or a set thereof, in ascending order of priority.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to receiving, at a cache, first data from a first node, assigning a first priority to the first data corresponding to a penalty associated with accessing the first data at the first node, the penalty indicative of time and resources consumed to access the first data; and
subsequently selecting the first data for replacement from the cache based in part on the first priority.

2. The method of claim 1, further comprising:
in response to receiving, at the cache, second data from a second node, wherein a penalty associated with accessing the second data at the second node is different from the penalty associated with accessing the first data at the first node, assigning a second priority to the second data corresponding to the penalty associated with accessing the second data at the second node, the second priority different from the first priority.

3. The method of claim 2, wherein the first node includes the cache and the second node is remote from the cache.

4. The method of claim 1, further comprising:
in response to receiving, at the cache, second data from the first node, wherein a penalty associated with accessing the second data is different from the penalty associated with accessing the first data, assigning a second priority to the second data corresponding to the penalty associated with accessing the second data and different from the first priority.

5. The method of claim 1, wherein the penalty is based on one or more of latency, bandwidth, and energy expended in accessing the first data at the first node.

6. The method of claim 5, wherein the latency is a fixed latency representative of a statistical analysis for access times at the first node.

7. The method of claim 5, wherein the latency is based on monitoring of memory access times at the first node.

8. The method of claim 1, wherein the first priority is based in part on a value provided by execution of an instruction at a processor core.

9. The method of claim 1, wherein selecting is based in part on recency of use of the first data by a processor core.

10. A method comprising:
selecting, by a cache controller, first data for eviction from a cache based in part on a first priority associated with the first data, wherein the first priority corresponds to a first penalty indicative of time and resources consumed to fill a cache miss for the first data.

11. The method of claim 10, wherein the first penalty is based on one or more of latency, bandwidth, and energy expended in accessing the first data at a first node from which the first data was received at the cache.

12. The method of claim 11, wherein the latency is a fixed latency representative of a statistical analysis for access times at the first node.

13. The method of claim 11, wherein the latency is based on monitoring of access times at the first node.

14. The method of claim 10, further comprising:
receiving the first data from a first node;
receiving second data from a second node; and
assigning a second priority to the second node based on a second penalty associated with filling a cache miss at the second node, the second priority different from the first priority.

15. A processing system, comprising:
a cache; and
a cache controller configured to select first data for eviction from the cache based in part on a first priority associated with the first data, wherein the first priority corresponds to a first penalty indicative of time and resources consumed to fill a cache miss for the first data.

16. The processing system of claim 15, further comprising:
a first node including the cache;
a second node, wherein a second penalty associated with filling a cache miss at the second node is different from the first penalty; and
wherein the cache controller is to select second data for eviction from the cache based on part on a second priority associated with the second data, the second priority based on the second penalty.

17. The processing system of claim 15, wherein the first penalty is based on one or more of latency, bandwidth, and energy expended in accessing the first data at a first node from which the first data was received at the cache.

18. The processing system of claim 17, wherein the cache controller is further configured to select the first data for eviction from the cache based in part on recency of use of the first data.

19. The processing system of claim 18, wherein the latency is a fixed latency representative of a statistical analysis for access times at the first node.

20. The processing system of claim 18, wherein the latency is based on monitoring of access times at the first node.
